(19) United States
(12) Patent Application Publication
(10) Pub. No.: US 2005/0255826 A1
(43) Pub. Date: Nov. 17, 2005

(54) Cellular telephone based surveillance system

(76) Inventors: Kent B. Wittenburg, Lynnfield, MA (US); Richard C. Waters, Concord, MA (US); Paris Smaragdis, Brookline, MA (US)

Correspondence Address: Patent Department;Mitsubishi Electric Research Laboratories, Inc., 201 Broadway, Cambridge, MA, 02139, US

(21) Appl. No.: 10/844,242

(22) Filed: May 12, 2004

(51) Int. Cl. H04M 11/00; H04Q 7/20

(52) U.S. Cl. 455/404.2; 455/456.1; 455/66.1; 455/556.1

(57) ABSTRACT

The invention provides sensors and event monitoring to a cellular telephone to perform surveillance. Using audio and visual sensing capabilities, an environment can be monitored to detect significant surveillance events and to trigger surveillance alerts in response to the events, or to report current sensor information in response to an in-coming call.

### FIELD OF THE INVENTION

The present invention relates generally to cellular telephones, and more particularly to using cellular telephones for surveillance and environment monitoring.

### BACKGROUND OF THE INVENTION

Prior art surveillance systems typically require specialized equipment and a fixed infrastructure, such as cameras, microphones, video recording devices, and networks. Such surveillance systems are optimized for fault tolerance and reliability, which makes those systems costly to construct and maintain. Those prior art surveillance systems are impractical for lightweight, mobile, and non-critical applications.

On the other hand, modem mobile cellular telephones often include a camera. The common camera equipped cellular telephone is primarily designed for person-to-person interaction.

It is desired to adapt cellular telephones for surveillance applications.

### SUMMARY OF THE INVENTION

The invention provides a cellular telephone based surveillance system with capabilities to perform surveillance and environment monitoring. Therefore, a cellular telephone is equipped with a set of one or more environmental sensors. The sensors can sense audio, visual, and other physical signals from the surrounding environment.

The signals are analyzed, and significant surveillance events are detected from the analyzed signals. In response to detecting the events, a set of actions can be generated to notify a user, or emergency agencies, such as the police and fire department. The events can also be recorded for later review.

The user can also activate the monitoring or request status by placing an incoming call to the cellular telephone from a remote location.

### BRIEF DESCRIPTION OF THE DRAWINGS

FIG. 1 is front view of a cellular telephone based surveillance system according to the invention;

FIG. 2 is a block diagram of a cellular telephone based surveillance system according to the invention; and

FIG. 3 is a flow diagram of a surveillance method according to the invention.

### DETAILED DESCRIPTION OF THE PREFERRED EMBODIMENT

System Structure

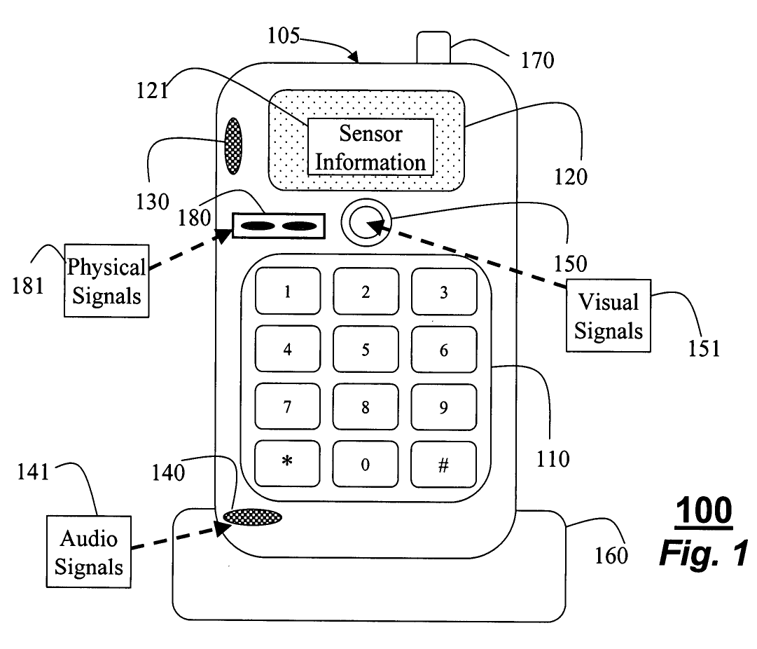

FIG. 1 shows a cellular telephone based surveillance system 100 according to the invention. The system 100 includes a cellular telephone 105. The telephone 105 includes a keypad 110, a display unit 120, and a loudspeaker 130. These are conventional. It should also be understood that the telephone includes a wireless communications interface, and one or more microprocessors. A method according to the invention, described below, can be implemented by the one or more microprocessors.

In addition, the system 100 includes a set of one or more embedded environmental sensors arranged on the cellular telephone 105. The environmental sensors can include one or more microphones 140, one or more cameras 150, and a set of one or more physical sensors 180, e.g., a smoke detector, a temperature detector, a gas detector, a water detector, an accelerometer, a motion detector. The sensors can be located anywhere on the telephone 105, e.g., front, back, sides, or internal.

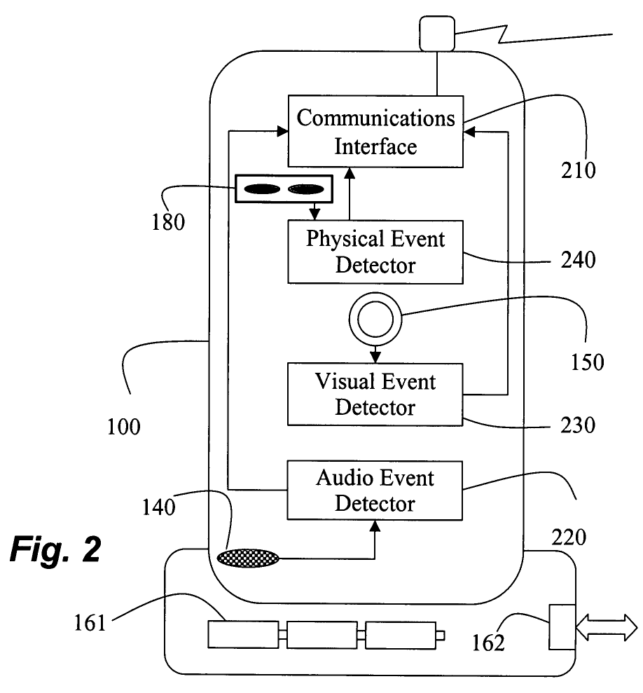

The system 100 can be placed in a cradle 160 for ‘hands-free’ operation as described herein. The cradle can also provide continuous power 161 and a network interface 162, see FIG. 2. Communication is achieved via an antenna 170 or the interface 162. During continuous extended operations, the communications interface can be idle, and only the sensing operations can be active as described below. The system 100 can also include a storage device, such as a flash memory or a disk.

System Operation

During operation, the set of one or more sensors 140, 150, and 180 of the system 100 acquires signals from the environment in which the system is operating. These signals can include audio signals 141 acquired by the one or more microphones 140, visual signals 151 acquired by the camera 150 in the form of still images or a video, and other environmental physical signals 181 acquired by the set of physical sensors 180, such as for temperature. The audio, visual and other environmental signals 141, 151 and 181 are analyzed to detect significant surveillance events as described below. The sensed signals, after analysis, can be displayed as sensed information 121 on the display unit 120.

Surveillance Method

Therefore, as shown in FIG. 2, the surveillance system 100 includes a wireless communications interface 210 connected to an audio event detector 220, which is connected to the microphone 140, a visual event detector 230, which is connected to the camera 150, and a physical event detector 240, which is connected to the physical sensors 180.

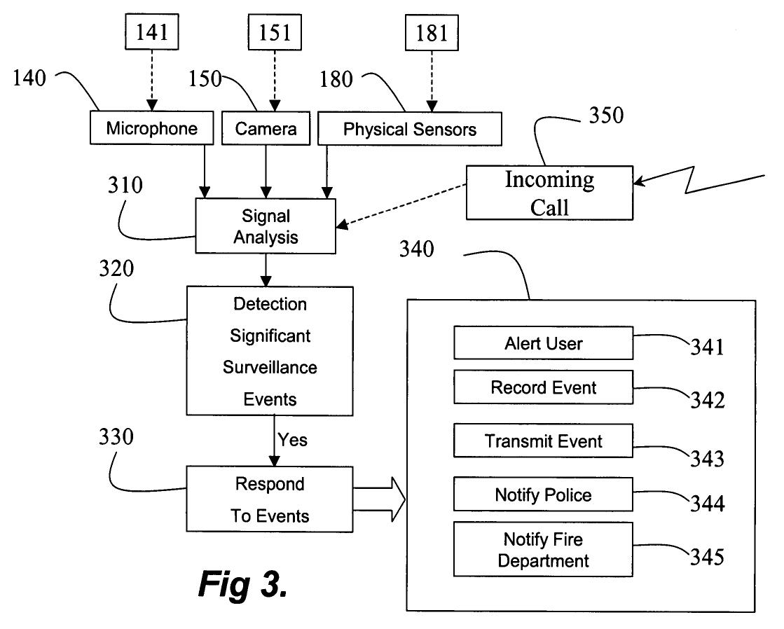

FIG. 3 is a flow diagram of a surveillance method 300 according to the invention. It should be understood, that the method can be implemented by software operating on processors inside the cellular telephone. In addition, some of the processing can be performed by external computers systems. The environmental signals acquired by the microphone, camera, and physical sensors are analyzed 310 to detect 320 significant surveillance events in the environment.

Responsive Surveillance Actions

In response to detecting the events, the surveillance system 100 can take a number of actions 340. For example, an output signal can be generated for the loudspeaker 130 to alert 341 the user. The event can be recorded 342. The events can be transmitted 343 to one or more preprogrammed telephone numbers. A police department can be notified 344, or the fire department can be called 345.

Audio Signals

The audio signal analysis can detect a sudden change in volume or frequency of the audio signal, e.g., sudden silence in a room that normally has some amount of background noise, or a noise in a room that should otherwise be silent. Speech in a room, where there should not be any, a person in distress, a door opening, and the like. The audio analysis can also include speech or sound recognition.

Visual Signals

The visual signal analysis can detect a sudden change in the intensity or color of light, e.g., a room going dark, or a light being turned on. The visual analysis can also perform motion detection, e.g., a moving object in an environment that should be empty, and pattern recognition to determine a correct or faulty operation of machinery.

Physical Signals

The physical analysis can detect changes in temperature, air quality, or motion of the cellular telephone itself, using e.g., a GPS sensor.

Remote Activation

In addition to initiating action based on detected information, a user can activate the surveillance system 100 remotely at any time in order to obtain currently sensed information, or a history of events. In this case, an incoming call 350 initiates the analysis.

Applications

In order to illustrate the use of the invention, consider the following scenarios, which employ sensing abilities to trigger surveillance actions on the system.

Audio Triggered Monitoring

The surveillance system according to the invention can be used to of monitor children. In a large house, this is a problem. A parent can place the cellular telephone in proximity to a child. The system can be instructed to detect the sound of crying and other unusual sounds, or just to monitor the sound levels in the room. After the system detects a preprogrammed event, the telephone can send a message to the user alerting them of the situation, and optionally sending the user an example of the sound clip that has been acquired. This way the user can evaluate the surveillance situation and take appropriate action. In the case that the system includes multiple microphones, a source of the audio signal can be localized.

Visual Triggered Monitoring

The visual surveillance can be used to monitor a secure room. In this case, the user leaves the cellular telephone in the space to be surveyed with the instructions to detect motion and visual activity. Upon detection of these events, the telephone can again take appropriate action, which in this case can include recording the events as a history for later review. An image or video clip can also be transmitted.

Physical Triggered Monitoring

The physical surveillance can be used to detect unusual physical events. For example, the surveillance system can be left in a building with instructions to monitor the temperature. Upon detecting too low a temperature that might cause water pipes to freeze, the phone can generate a remote alarm.

Audio/Video Triggered Monitoring

The audio and visual detection can be used in conjunction to strengthen the quality of the surveillance event detection. For example, the surveillance system is placed in an automobile in a garage. The system is instructed to initiate and transmit an audio-visual recording when someone enters the garage and turns on the lights in the garage, or starts the automobile.

Continuous Extended Operation

In order to facilitate continuous extended operation, the cradle 160 can provide a stable support and power for long amounts of time. In addition, the cradle can also be used as a network interface between multiple surveillance systems, or other computer systems. In the case, the computer system are used to perform the analysis, detection, and generating.

The cellular telephone can communicate with the computer system via the cradle, or via a wireless links. An uplink can be used to communicate data to a remote device, and a downlink can be used to communicate operating instructions to the system. This can greatly increase the complexity of the signal analysis and detection.

### EFFECT OF THE INVENTION

The invention provides surveillance functions for cellular telephones. Audio, visual, and physical signals are acquired from the environment in which the telephone operates. The signals are analyzed to detect significant surveillance events. Responses to the detected events are generated either locally, or remotely.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A surveillance system, comprising:
a cellular telephone;
a set of environmental sensors arranged on the cellular telephone, the set of environmental sensors configured to acquire environment signals from an environment surrounding the cellular telephone;
means for analyzing the environment signals;
means for detecting significant surveillance events from the analyzed signals; and
means for generating a set of actions in response to the detected surveillance events.

2. The system of claim 1, in which the set of environmental sensors includes a microphone for acquiring audio signals.

3. The system of claim 1, in which the set of environmental sensors includes a camera for acquiring visual signals.

4. The system of claim 1, in which the set of environmental sensors includes a set of physical sensors for acquiring physical signals.

5. The system of claim 4, in which the set of physical sensors includes a temperature sensor.

6. The system of claim 4, in which the set of physical sensors includes a smoke detector.

7. The system of claim 1, further comprising:
a cradle for holding the cellular telephone at a fixed location in the environment.

8. The system of claim 1, further comprising:
a storage device configured to record a history of the significant surveillance events.

9. The system of claim 1, in which the set of actions includes alerting the user of the cellular telephone.

10. The system of claim 1, in which the set of actions includes alerting a police department.

11. The system of claim 1, in which the set of actions includes alerting a fire department.

12. The system of claim 1, in which the set of actions includes calling a predetermined telephone number.

13. The system of claim 1, in which the set of actions includes transmitting an audio clip of the significant surveillance event.

14. The system of claim 1, in which the set of actions includes transmitting an image of the significant surveillance event.

15. The system of claim 1, in which the set of actions includes transmitting a video clip image of the significant surveillance event.

16. The system of claim 1, including means for reporting current sensed signals.

17. The system of claim 1, in which the cellular telephone further comprises:
a display unit; and
means for displaying the surveillance events on the display unit.

18. The system of claim 1, in which the set of environmental sensors includes a plurality of microphones for acquiring audio signals and a location of a source of the audio signals.

19. The system of claim 1, in which a location of the cellular telephone is determined.

20. The system of claim 1, in which the analyzing, detecting and generating is initiated by an incomming call to the cellular telephone.

21. The system of claim 1, in which the set of actions includes generating a history of the surveillance events.

22. The system of claim 1, in which the means for analyzing, the means for detecting and the means for generating are arranged on the cellular telephone.

23. The system of claim 1, in which the means for analyzing, the means for detecting and the means for generating are external to the cellular telephone.

24. A surveillance method, comprising:
acquiring environment signals from an environment with a set of sensors arranged on a cellular telephone;
analyzing the environment signals;
detecting significant surveillance events from the analyzed signals; and
generating a set of actions in response to the detected surveillance events.
